(19) United States
(12) Patent Application Publication
(10) Pub. No.: US 2025/0273689 A1
(43) Pub. Date: Aug. 28, 2025

(54) POSITIVE ELECTRODE LITHIUM-RICH COMPOSITE CURRENT COLLECTORS AND METHODS FOR PREPARING THE SAME

(71) Applicant: JIANGYIN NANOPORE INNOVATIVE MATERIALS TECHNOLOGY LTD, Wuxi (CN)

(72) Inventors: Chenghao WANG, Wuxi (CN); Xuefa LI, Wuxi (CN); Guoping ZHANG, Wuxi (CN)

(21) Appl. No.: 18/857,818

(22) PCT Filed: Apr. 20, 2023
(86) PCT No.: PCT/CN2023/089499

§ 371 Date: Oct. 18, 2024

(30) Foreign Application Priority Data
Apr. 20, 2022 (CN) 202210414344.1
May 27, 2022 (WO) PCT/CN2022/095425

(51) Int. Cl. H01M 4/66; H01M 4/02; H01M 4/04

(52) U.S. Cl. CPC H01M 4/667; H01M 4/0404; H01M 4/0416; H01M 4/0423; H01M 4/0471; H01M 4/661; H01M 4/663; H01M 4/668; H01M 2004/028

(57) ABSTRACT

The present application relates to a lithium-rich composite current collector for use in a positive electrode and a method for preparing the same. The lithium-rich composite current collector includes a polymer layer, two deposited aluminum layers, and two lithium-rich layers, wherein the two deposited aluminum layers are respectively disposed on two opposite surfaces of the polymer layer; and the two lithium-rich layers are respectively disposed on surfaces of the two deposited aluminum layers away from the polymer layer. By disposing the deposited aluminum layers and the lithium-rich layers on the surfaces of the polymer layer, the lithium-rich composite current collector has relatively high strength and ductility. Additionally, due to the presence of the lithium-rich layers, the lithium metal therein can compensate for the initial consumption of active lithium in the process of forming the solid electrolyte interface (SEI) film in the battery, and increase the amount of active lithium in the battery, which can increase the capacity and the cycle life of the battery.

### CROSS-REFERENCE TO RELATED APPLICATIONS

This application claims priority to and benefits of Chinese patent application No. 2022104143441, filed Apr. 20, 2022, and International Application No. PCT/CN2022/095425, filed May 27, 2022, all of which are incorporated herein by reference in their entireties.

### TECHNICAL FIELD

The present application relates to the field of battery technology, and in particular to a positive electrode lithium-rich composite current collector and a method for preparing the same.

### BACKGROUND

A current collector is a configuration or a member configured to collect electric currents. In a lithium-ion battery, a current collector can be referred to be a metal foil, such as a copper foil or an aluminum foil, and may also generally include an electrode tab. By coating onto the current collector, active material particles in a powder form are electrically connected together, so that the current collector can collect and output the electric currents generated by the active material particles, and input the external electric current to the active material particles.

The positive electrode current collector of a conventional non-aqueous secondary battery is a high-purity aluminum foil. Such high-purity aluminum foil is prepared by adding aluminum ingots to an electrolytically produced aluminum melt, and spraying a refining agent into the melt with pure nitrogen or pure argon for refining. The melt is stirred evenly and then allowed to stand. Then aluminum-titanium-boron wires are added into the melt in a reverse direction to refine aluminum grains. Then the aluminum liquid is degassed with pure nitrogen or pure argon in a degassing box, and filtered and purified with a foam ceramic filter. The purified aluminum liquid is sent to a casting and rolling machine for casting and rolling a billet with a thickness ranging from 5.0 to 10.0 mm. Then the billet is cold-rolled and annealed to finally obtain the required thickness of the aluminum foil to produce the current collector.

The above-described current collector is substantially made of single metal material to play only one function of carrying the positive electrode in the battery and collecting currents, but may not provide further benefits.

### SUMMARY

Thus, there is a need to provide an enhanced composite current collector for use in positive electrode, such as a lithium-rich composite current collector, and a method for preparing the same, aiming at improving the property of the current collector and providing additional benefits beyond the fundamental functions.

In an aspect of the present application, a lithium-rich composite current collector for positive electrode is provided, which includes a polymer layer, a metal layer, and a lithium-rich layer. The metal layer is disposed on a surface of the polymer layer. The lithium-rich layer is disposed on a surface of the metal layer away from the polymer layer.

In another aspect of the present application, a lithium-rich composite current collector for positive electrode is provided, which includes a polymer layer, two metal layers, and two lithium-rich layers. The two metal layers are respectively disposed on two opposite surfaces of the polymer layer. The two lithium-rich layers are disposed on surfaces of the two metal layers away from the polymer layer.

By disposing the metal layer(s) and the lithium-rich layer(s) on the surface(s) of the polymer layer, the lithium-rich composite current collector for use in a positive electrode can have relatively high strength and ductility. Additionally, due to the presence of the lithium-rich layer(s), the lithium metal therein can compensate for the initial consumption of active lithium in the process of forming the solid electrolyte interface (SEI) film in the battery, and increase the amount of active lithium in the battery, which can increase not only the capacity but also the cycle life of the battery.

In an embodiment, the metal layer is a deposited aluminum layer.

In an embodiment, the metal layer is substantially made of aluminum.

In an embodiment, a weight amount of aluminum in the deposited aluminum layer is equal to or greater than 99.8%.

In an embodiment, a thickness of the lithium-rich composite current collector for positive electrode ranges from 3 microns (μm) to 30 μm. In an embodiment, a thickness of the polymer layer ranges from 1 μm to 25 μm. In an embodiment, a thickness of the metal layer ranges from 0.3 μm to 3.0 μm. In an embodiment, a thickness of each lithium-rich layer ranges from 0.5 μm to 2 μm.

In an embodiment, a peeling force between the metal layer and the polymer layer is equal to or greater than 2 N/m.

In an embodiment, the polymer layer includes a polymer film made of at least one polymer selected from polyethylene, polypropylene, polyethylene terephthalate (PET), and polyphenylene sulfide (PPS).

In an embodiment, the lithium-rich layer includes polyvinylidene difluoride (PVDF) and carbon-coated lithium metal particles. In an embodiment, PVDF has a homopolymer structure. In an embodiment, the carbon-coated lithium metal particles include lithium metal and a carbon material completely encapsulating the lithium metal. In an embodiment, the carbon material in the carbon-coated lithium metal particles comprise at least one selected from carbon nanotubes, carbene (SP), isotropic spherical artificial graphite (KS-6), graphene, and vapor-grown carbon fibers (VGCF).

In an embodiment, the carbon-coated lithium metal particles are formed by:
jet-milling lithium metal with an inert gas to obtain lithium powder with a D50 particle size ranging from 0.5 μm to 1.0 μm;
adding the lithium powder and carbon material powder to a reactor, stirring them in a vacuum environment for carbon coating, thereby obtaining carbon-coated lithium powder; and
sintering the carbon-coated lithium powder in the vacuum environment, thereby forming the carbon-coated lithium metal particles.

In an embodiment, the polymer layer has one or more parameters selected from: a puncture resistance greater than or equal to 100 gram-force (gf), a tensile strength greater or equal to 200 MPa in the machine direction (MD), a tensile strength greater than or equal to 200 MPa in the transverse direction (TD), an elongation greater than or equal to 30% in the MD, and an elongation greater than or equal to 30% in the TD.

In a second aspect of the present application, a method for preparing a lithium-rich composite current collector for use in a positive electrode is provided, which is used to prepare the lithium-rich composite current collector described in any one of the above embodiments. The method comprises:
evaporating metal to deposit a metal layer on a surface of a polymer layer by using vacuum coating equipment; and
forming a lithium-rich layer by coating a carbon-coated lithium metal slurry on a surface of the metal layer away from the polymer layer, thereby obtaining the lithium-rich composite current collector for use in positive electrode.

In an embodiment, the method further comprises:
providing carbon-coated lithium metal particles;
dissolving PVDF in an organic solvent, and stirring for a period of time ranging from 60 to 100 minutes (min) under vacuum to obtain a mixture; and
adding the carbon-coated lithium metal particles to the mixture, and stirring them for a period of time ranging from 100 to 150 min under vacuum to obtain the carbon-coated lithium metal slurry.

In an embodiment, the method further comprises:
jet-milling lithium metal with an inert gas to obtain lithium powder with a D50 particle size ranging from 0.5 μm to 1.0 μm;
adding the lithium powder and carbon material powder to a reactor, stirring them in a vacuum environment for carbon coating, thereby obtaining carbon-coated lithium powder; and
sintering the carbon-coated lithium powder in the vacuum environment, thereby forming the carbon-coated lithium metal particles.

### BRIEF DESCRIPTION OF THE DRAWINGS

The drawings constituting a part of the present disclosure are used to provide a further understanding of the present disclosure. The schematic embodiments and descriptions of the present application are used to explain the present disclosure and do not constitute an improper limitation to the present disclosure.

In order to clearly explain technical solutions of the present disclosure, the following drawings, which are to be referred in the description of the embodiments, are briefly described below. The drawings in the following description only show some embodiments of the present disclosure, and those skilled in the art can obtain other drawings according to the following drawings without any creative work.

FIG. 1 is a schematic structural view of a lithium-rich composite current collector for use in a positive electrode according to an embodiment of the present disclosure.

FIG. 2 is a schematic structural view of a carbon-coated lithium metal particle in a lithium-rich layer as shown in FIG. 1.

FIG. 3 is a flow chart of a method for preparing a lithium-rich composite current collector for use in a positive electrode according to an embodiment of the present disclosure.

### REFERENCE SIGNS

100, positive electrode lithium-rich composite current collector; 110, polymer layer; 120, metal layer; 130, lithium-rich layer.

### DETAILED DESCRIPTION

In order to achieve the above objectives, features and advantages of the present application more clear and understandable, embodiments of the present application will be described in detail below with reference to the accompanying drawings. In the following description, many specific details are explained to make the present application fully understandable. However, the present application can be implemented in many other ways different from those described herein, and those skilled in the art can make similar improvements without departing from the connotation of the present application. Therefore, the present application is not limited by the specific embodiments disclosed below.

Unless otherwise specified, all the technical and scientific terms used herein shall be understood as the same meaning with those commonly accepted by a person skilled in the art. Such terms, as used herein, are for the purpose of describing exemplary examples of, and without limiting, the present application. In the case of using “including”, “having”, and “comprising” as described herein, it is intended to cover the non-exclusive inclusion.

In the description of the present application, the term “and/or” is used to describe relationships of associated objects, covering three cases. For example, the wording “A and/or B” means that there are three possibilities: A alone, B alone, and a combination of A and B. In addition, the character “/” in the present application generally indicates that the contextual objects are in an “or” relationship.

In the description of the present application, it should be understood that the terms “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate the orientations or positional relationships on the basis of the drawings. These terms are only for describing the present application and simplifying the description, rather than indicating or implying that the related devices or elements must have the specific orientations, or be constructed or operated in the specific orientations, and therefore cannot be understood as limitations of the present application.

In addition, the terms “first” and “second” are used merely as labels to distinguish one element having a certain name from another element having the same name, and cannot be understood as indicating or implying any priority, precedence, or order of one element over another, or indicating the quantity of the element. Therefore, the element modified by “first” or “second” may explicitly or implicitly includes at least one of the elements. In the description of the present application, “a plurality of” means at least two, such as two, three, etc., unless otherwise specifically defined.

In the present application, unless otherwise clearly specified or defined, the terms “installed”, “connected”, “coupled”, “fixed” and other terms should be interpreted broadly. For example, an element, when being referred to as being “installed”, “connected”, “coupled”, “fixed” to another element, unless otherwise specifically defined, may be fixedly connected, detachably connected, or integrated to the other element, may be mechanically connected or electrically connected to the other element, and may be directly connected to the other element or connected to the other element via an intermediate element. For those of ordinary skill in the art, the specific meaning of the above-mentioned terms in the present application can be understood according to specific circumstances.

In the present application, unless otherwise specifically defined, an element, when being referred to as being located “on” or “under” another element, may be in direct contact with the other element or contact the other element via an intermediate element. Moreover, the element, when being referred to as being located “on”, “above”, “over” another element, may be located right above or obliquely above the other element, or merely located at a horizontal level higher than the other element; the element, when being referred to as being located “under”, “below”, “beneath” another element, may be located right below or obliquely below the other element, or merely located at a horizontal level lower than the other element.

It should be noted that an element, when being referred to as being “fixed” or “mounted” to another element, may be directly fixed or mounted to the other element or via an intermediate element. Such terms as “vertical”, “horizontal”, “up”, “down”, “left”, “right” and the like used herein are for illustrative purposes only and are not meant to be the only ways for implementing the present application.

The embodiments of the present application will be described below with reference to the accompanying drawings.

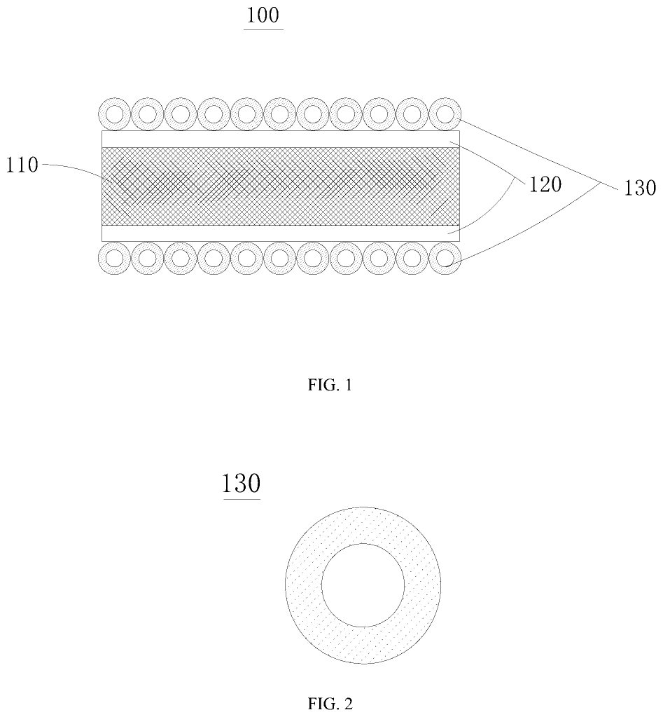

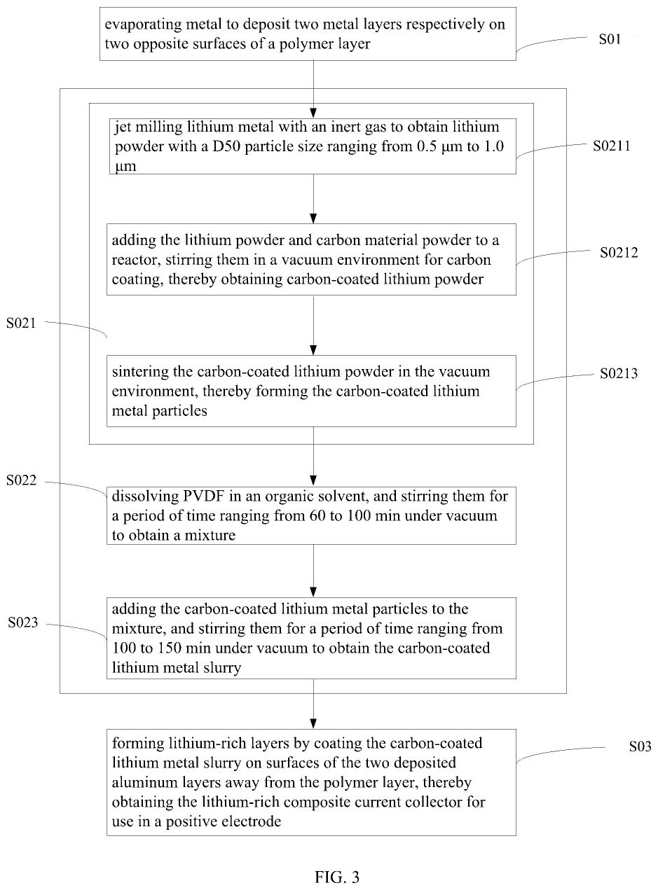

Referring to FIG. 1, in an embodiment of the present application, a positive electrode lithium-rich composite current collector 100 includes a polymer layer 110, two metal layers 120, and two lithium-rich layers 130. The two metal layers 120 are respectively disposed on two opposite surfaces of the polymer layer 110. The two lithium-rich layers 130 are respectively disposed on surfaces of the two metal layers 120 away from the polymer layer 110.

A lithium-ion battery is a secondary battery (i.e., a rechargeable battery) mainly operating on the basis of lithium ions transferring between positive and negative electrodes. During the charge and discharge processes, Li⁺ intercalates and deintercalates back and forth between the two electrodes. During the charge process, Li⁺ deintercalates from the positive electrode, transfers through the electrolyte, and intercalates into the negative electrode, the negative electrode being in a lithium-rich state; vice versa during the discharge process.

The polymer layer 110 can be made of a lightweight polymer material, so that the weight of the positive electrode lithium-rich composite current collector 100 is less than that of a pure metal current collector.

The metal layers 120 can be deposited aluminum layers. The deposited aluminum layers are disposed on the surfaces of the polymer layer 110, thereby improving the strength of the polymer layer 110 due to the physical properties of the metal.

The lithium-rich layers 130 include lithium element, which is used to compensate for the initial consumption of active lithium in the process of forming the SEI film. The amount of lithium in the lithium-rich layers 130 is not limited. Within a certain range, the higher the amount of lithium is, the more it can compensate for the initial consumption of active lithium in the battery, and the higher the amount of active lithium in the battery is. The term “lithium-rich” disclosed herein, such as in the lithium-rich layer 130, refers to that, as compared with the positive electrode current collector in the prior art where the active lithium is consumed and not replenished during the formation of the SEI film in the battery, the active lithium in the battery of the present embodiment is replenished, so that the lithium amount in the battery of the present embodiment is greater than that in the conventional battery.

By disposing the metal layers 120 and the lithium-rich layers 130 on the surfaces of the polymer layer 110, the positive electrode lithium-rich composite current collector 100 has relatively high strength and ductility. Additionally, due to the presence of the lithium-rich layers 130, the lithium metal therein can compensate for the initial consumption of active lithium in the process of forming the SEI film in the battery, and increase the amount of active lithium in the battery, which can increase not only the capacity but also the cycle life of the battery.

According to some embodiments of the present application, optionally, the thickness of the lithium-rich composite current collector 100 for use in positive electrode ranges from 3 μm to 30 μm, wherein a thickness of the polymer layer 110 ranges from 1 μm to 25 μm, a thickness of the metal layer 120 ranges from 0.3 μm to 3.0 μm, and a thickness of the lithium-rich layer 130 ranges from 0.5 μm to 2 μm. The thickness of the lithium-rich composite current collector 100 for use in positive electrode is less than that of a pure metal current collector, leaving more space for the active material in the battery.

According to some embodiments of the present application, optionally, a peeling force between the metal layers 120 and the polymer layer 110 is equal to or greater than 2 N/m, which can reduce the cracking and peeling of the metal layers 120 and the polymer layer 110 under force at a short-circuit point. The peeling force refers to the maximum force per unit width required to peel the bonded materials from the contact surface, reflecting the bonding strength of the materials.

According to some embodiments of the present application, optionally, the polymer layer 110 includes a polymer film made of at least one polymer selected from polyethylene, polypropylene, PET, and PPS. The polymer layer 110 may include one or more of the above polymer materials, and various combinations of the above polymer materials all fall within the scope of the present application.

According to some embodiments of the present application, optionally, a weight amount of aluminum in the deposited aluminum layers is equal to or greater than 99.8%.

Referring to FIG. 2, according to some embodiments of the present application, optionally, the lithium-rich layer 130 includes PVDF and carbon-coated lithium metal particles. PVDF has a homopolymer structure. The structure of the carbon-coated lithium metal is shown in FIG. 2, wherein the core is lithium metal, and the outside of the lithium metal is wrapped by a large amount of carbon material. The carbon material in the carbon-coated lithium metal includes at least one of carbon nanotubes, SP, KS-6, \graphene, and VGCF. The carbon material in the carbon-coated lithium metal may include one or more of the above materials, and various combinations of the above materials all fall within the scope of the present application.

PVDF has good dielectric and piezoelectric properties. The carbon material is often used as a conducting agent in a battery. The carbon material in the lithium-rich layer 130 can improve the electron transport capability of the positive electrode lithium-rich composite current collector 100. The lithium metal of the lithium-rich layer 130 can compensate for the initial consumption of active lithium in the process of forming the SEI film in the battery, and increase the amount of active lithium in the battery, which can increase not only the capacity but also the cycle life of the battery.

In some embodiments, the carbon-coated lithium metal can include lithium metal and a carbon material completely encapsulating the lithium metal. During the preparation of the positive electrode lithium-rich composite current collector, the carbon material prevents the lithium metal from contacting with oxygen gas, which improves safety. Moreover, pre-lithiation of the carbon-coated lithium metal can achieve relatively good stability and safety.

In initial charge of the lithium battery, the positive electrode is at a higher electric potential, and the lithium metal in the carbon-coated lithium metal loses electrons to form lithium ions. The electrons pass through the carbon layer and the current collector and then move to the negative electrode. The lithium ions release from the carbon layer and enter into the electrolyte. As such, the initial charge capacity of the lithium battery is improved. After releasing the lithium ions, the carbon material is electrical conductive, which can reduce the interface resistance between the current collector and the positive electrode active material.

The carbon-coated lithium metal can be formed by: of:
jet-milling lithium metal with an inert gas to obtain lithium powder with a D50 particle size ranging from 0.5 μm to 1.0 μm;
adding the lithium powder and carbon material powder to a reactor, stirring them in a vacuum environment for carbon coating, thereby obtaining carbon-coated lithium powder; and
sintering the carbon-coated lithium powder in a vacuum environment, thereby forming the carbon-coated lithium metal particles.

In this way, the carbon material can completely encapsulate the lithium metal.

According to some embodiments of the present application, optionally, the polymer layer has one of the following properties: a puncture resistance greater than or equal to 100 gf, a tensile strength greater than or equal to 200 MPa in the MD, a tensile strength greater than or equal to 200 MPa in the TD, an elongation greater than or equal to 30% in the MD, and an elongation greater than or equal to 30% in the TD.

The puncture resistance is an important parameter of a separator, which measures the strength of the separator by the force required for a needle to pass through the separator. The tensile strength is an important value of the material transiting from uniform plastic deformation to local concentrated plastic deformation, and is also the maximum bearing capacity of the material under a static tensile condition. The elongation (6) is a percentage of the total deformation (ΔL) of the gauge section after tensile fracture of the sample to the original length (L) of the gauge section: δ=ΔL/L×100%.

In the positive electrode lithium-rich composite current collector 100 in the above embodiments, since the metal layers 120 are disposed on the surfaces of the polymer layer 110, the positive electrode lithium-rich composite current collector 100 has relatively high strength and ductility. The positive electrode lithium-rich composite current collector 100 has a puncture resistance greater than or equal to 50 gf, a tensile strength greater than or equal to 150 MPa in the MD, a tensile strength greater than or equal to 150 MPa in the TD, an elongation greater than or equal to 10% in the MD and an elongation greater than or equal to 10% in the TD. Moreover, due to the presence of the lithium-rich layers 130, the carbon material enhances the electron transport capability of the composite current collector and the lithium metal increases the amount of active lithium in the battery. The upper and lower sheet resistances of the positive electrode lithium-rich composite current collector 100 are both less than or equal to 50 mΩ. Sheet resistance is also known as square resistance, which refers to the resistance between the two sides of a square film of a conductive material.

The present application further provides a method for preparing a lithium-rich composite current collector 100 for use in a positive electrode, which is used to prepare the lithium-rich composite current collector 100 for use in a positive electrode described in any one of the above embodiments. The method comprises: S01: evaporating metal to deposit two metal layers 120 respectively on two opposite surfaces of a polymer layer 110, wherein vacuum coating equipment can be used to vapor-deposit metal on the surfaces of the polymer layer 110, and the vacuum coating equipment can be a magnetron sputtering device or a vacuum evaporation device. S03: forming lithium-rich layers 130 by coating a carbon-coated lithium metal slurry on surfaces of the two metal layers 120 away from the polymer layer 110, thereby obtaining the lithium-rich composite current collector 110 for use in a positive electrode.

The metal is, for example, high-purity aluminum, sourced from a high-purity aluminum ingot. Aluminum metal from the high-purity aluminum ingot can be deposited onto the upper and lower surfaces of the polymer layer 110 through the vacuum evaporation device.

The evaporation parameters are as follows: the unwinding tension ranges from 5N to 30 N, the winding tension ranges from 5N to 25 N, the evaporation speed is greater than 10 m/min, the evaporation temperature is higher than 600° C., and the vacuum degree is lower than 8×10⁻² Pa.

The carbon-coated lithium metal slurry is coated on the surfaces of the two metal layers 120 away from the polymer layer 110, the coating step can be performed in an environment with a humidity of less than 1%.

In some embodiments, the step of S03: forming lithium-rich layers 130 by coating a carbon-coated lithium metal slurry on surfaces of the two metal layers 120 away from the polymer layer 110, is followed by cutting, winding, and vacuum packing the material, thereby obtaining the positive electrode lithium-rich composite current collector 110.

According to some embodiments of the present application, optionally, the method further comprises the step of S02: preparing the carbon-coated lithium metal slurry, which includes S021: providing carbon-coated lithium metal particles; S022: dissolving PVDF in an organic solvent, and stirring them for a period of time ranging from 60 to 100 min under vacuum to obtain a mixture; and S023: adding the carbon-coated lithium metal particles into the mixture, and stirring them for a period of time ranging from 100 to 150 min under vacuum to obtain the carbon-coated lithium metal slurry.

In step S022 and step S023, high-speed stirring can be used during the stirring, and the stirring speed can be greater than or equal to 500 r/min. In one embodiment, the stirring speed is 1000 r/min.

In some embodiments, the organic solvent can be N-methylpyrrolidone (NMP) or dimethylacetamide (DMAC). In one embodiment, NMP is used as the organic solvent. In the slurry, a mass ratio of the carbon-coated lithium metal to PVDF to NMP is 1:(0.01-0.015):(10-15).

NMP is an organic substance with a chemical formula of C₅H₉NO, which is a colorless to pale yellow transparent liquid with a slight ammonia odor. NMP is miscible with water in any proportion and soluble in various organic solvents, such as ethers, acetones, esters, halogenated hydrocarbons, and aromatic hydrocarbons, and can be mixed with almost all solvents.

According to some embodiments of the present disclosure, optionally, the step of S021: forming the carbon-coated lithium metal particles includes the following steps of: S0211: jet-milling lithium metal with an inert gas to obtain lithium powder with a D50 particle size ranging from 0.5 μm to 1.0 μm; S0212: adding the lithium powder and carbon material powder to a reactor, stirring them in a vacuum environment for carbon coating, thereby obtaining carbon-coated lithium powder; and S0213: sintering the carbon-coated lithium powder in the vacuum environment, thereby forming the carbon-coated lithium metal particles.

In the step of S0212, high-speed stirring can be used during the stirring, and the stirring speed can be greater than or equal to 500 r/min. In one embodiment, the stirring speed is 1000 r/min.

D50 is the particle size when the cumulative particle size distribution percentage of a sample reaches 50%. Physically, it means that the particles with a particle size of greater than this value account for 50%, and the particles with a particular size of less than this value also account for 50%. D50 is also known as the median diameter or median particle diameter.

In some embodiments, the step of S0213: sintering the carbon-coated lithium metal powder in the vacuum environment, thereby forming the carbon-coated lithium metal particles, is followed by vacuum sealing and packing the carbon-coated lithium metal particles for preservation.

### Example 1: A Positive Electrode Lithium-Rich Composite Current Collector 100 with a Thickness of about 8 μm was Prepared as Follows

1. A polymer film with a thickness of 4 μm and an aluminum ingot with a purity of 99.9% were selected and placed into the vacuum coating equipment respectively. By using the vacuum evaporation process, aluminum metal from the high-purity aluminum ingot was deposited onto the surfaces of the polymer layer using a vacuum evaporation device. The thickness of the aluminum layer on each of the upper and lower surfaces of the polymer layer was 1 μm. The evaporation parameters were as follows: the unwinding tension was 8 N, the winding tension was 6 N, the evaporation speed was 80 m/min, the evaporation temperature was 680° C., and the vacuum degree was 6×10−2 Pa.

2. Preparation of the carbon-coated lithium metal particles: Lithium metal was jet-milled with an inert gas to form lithium powder with a D50 particle size of 0.6 μm. The lithium powder was coated with the carbon powder by high-speed stirring in a reactor under vacuum (with a vacuum degree of 6×10⁻² Pa), and the coated powder with a D50 particle size of 0.8 μm was obtained. The coated powder was sintered under vacuum with a vacuum degree of 6×10⁻² Pa, and was then vacuum sealed and packed.

3. Preparation of the carbon-coated lithium slurry: PVDF was dissolved in an organic solvent, stirred at a high speed for 80 min under vacuum (with a vacuum degree of 6×10⁻² Pa), and then added with the prepared carbon-coated lithium metal particles and stirred at a high speed for 120 min under vacuum (with a vacuum degree of 6×10⁻² Pa). In the slurry, a mass ratio of the carbon-coated lithium metal to PVDF to NMP was 1:0.012:10.

4. The coating with the prepared carbon-coated lithium metal slurry was performed in an environment with a humidity of less than 1%.

5. The cutting, winding and vacuum packing were carried out after the coating.

Comparative Example 1: As a comparison, a conventional aluminum foil with a thickness of 8 μm as the positive electrode lithium-rich composite current collector was prepared as follows.

1. The electrolytically produced aluminum melt was introduced into a smelting furnace, and added with aluminum ingots accounting for 30% by weight of the aluminum melt. The melt temperature was controlled at 770° C. The mass percentages of the elements in the melt are controlled as Si: 0.15%, Fe: 0.48%, Cu: 0.13%, Mn: 1.3%, Ti: 0.03%, and the balance is Al.

A refining agent was sprayed into the melt with pure nitrogen or pure argon for refining. The melt was stirred evenly. After 9 min of refining, the melt was allowed to stand for 20 min. After removal of solids floating on the liquid surface, the aluminum liquid was placed into a static furnace. The temperature inside the static furnace was controlled at 755° C.

The aluminum liquid was then transported from the static furnace to a flow trough, and added with aluminum-titanium-boron wires in a reverse direction to refine the grains. Then the aluminum liquid was degassed with pure nitrogen or pure argon in a degassing box, and filtered and purified with a foam ceramic filter.

2. The purified aluminum liquid was sent to a casting and rolling machine for casting and rolling, and a billet with a thickness of 4.0 mm was obtained.

3. The billet was cold-rolled and annealed at 470° C. for 25 hours for homogenization.

4. The billet after the homogenization annealing was then cold-rolled to have a thickness of 0.5 mm, and then annealed at 300° C. for 15 hours for recrystallization.

5. The billet after the recrystallization annealing was rolled to form the aluminum foil with the thickness of 8 μm.

The 8-μm composite current collector in Example 1 was compared with the 8-μm conventional aluminum foil positive current collector in Comparative Example 1. The results are shown in the following table.

| | First | | MD | TD | | | |
|---|---|---|---|---|---|---|---|
| | cycle | Cycle | tensile | tensile | MD | TD | Puncture |
| | efficiency | life | strength | strength | elongation | elongation | resistance |
| Scheme | (%) | (week) | (MPa) | (MPa) | (%) | (%) | (gf) |
| Example 1 | 90 | 1500 | 300 | 280 | 33 | 30 | 320 |
| Comparative | 85 | 1200 | 189 | 175 | 6 | 4 | 95 |
| Example 1 | | | | | | | |

By comparison, the tensile strength and ductility of the positive electrode lithium-rich composite current collector 100 disclosed herein are greatly improved as compared with those of the conventional aluminum foil positive current collector with the same thickness. In addition, the lithium battery using the positive electrode lithium-rich composite current collector 100 disclosed herein has the first cycle efficiency that is increased by 5%, and the cycle life that is increased to be 1500 weeks in comparison with that of the lithium battery using the conventional aluminum foil positive current collector (i.e., 1200 weeks).

Finally, it should be noted that the above embodiments are only for the purpose of illustrating the present application and are not intended to limit the scope of the present application in any way. Although the present application has been described in detail with reference to the embodiments, it should be understood by those of ordinary skill in the art that various modifications to the technical solutions or equivalent substitutions to some or all of the technical features can be made without departing from the concept of the present application, and all fall within the protection scope of the present application. In particular, as long as there is no structural contradiction, all the technical features mentioned in the various embodiments can be combined arbitrarily. The present application is not limited to the specific embodiments disclosed herein, but includes all technical solutions falling within the scope of the claims.

What is claimed is:

1. A lithium-rich composite current collector for use in a positive electrode, comprising:
a polymer layer;
a metal layer; and
a lithium-rich layer,
wherein the metal layer is disposed on a surface of the polymer layer, and the lithium-rich layer is disposed on a surface of the metal layer away from the polymer layer.

2. The lithium-rich composite current collector of claim 1, wherein the metal layer is substantially made of aluminum.

3. The lithium-rich composite current collector of claim 2, wherein the weight amount of aluminum in the deposited aluminum layers is equal to or greater than 99.8%.

4. The lithium-rich composite current collector of claim 1, wherein the current collector has at least one feature selected from:
a thickness of the lithium-rich composite current collector ranging from 3 μm to 30 μm,
a thickness of the polymer layer ranging from 1 μm to 25 μm,
a thickness of the metal layer ranging from 0.3 μm to 3.0 μm, and
a thickness of the lithium-rich layer ranging from 0.5 μm to 2 μm.

5. The lithium-rich composite current collector of claim 1, wherein the peeling force between the metal layers and the polymer layer is equal to or greater than 2 N/m.

6. The lithium-rich composite current collector of claim 1, wherein the polymer layer comprises a polymer film made of at least one polymer selected from polyethylene, polypropylene, polyethylene terephthalate (PET), and polyphenylene sulfide (PPS).

7. The lithium-rich composite current collector of claim 1, wherein the lithium-rich layer comprises polyvinylidene fluoride (PVDF) and carbon-coated lithium metal particles, wherein PVDF has a homopolymer structure.

8. The lithium-rich composite current collector of claim 7, wherein the carbon-coated lithium metal particles comprise lithium metal and a carbon material completely encapsulating the lithium metal.

9. The lithium-rich composite current collector of claim 8, wherein the carbon material in the carbon-coated lithium metal particles comprises at least one selected from carbon nanotubes, carbene (SP), isotropic spherical artificial graphite (KS-6), graphene, and vapor-grown carbon fibers (VGCF).

10. The lithium-rich composite current collector of claim 8, wherein the carbon-coated lithium metal particles are obtainable by:
jet-milling lithium metal with an inert gas to obtain lithium powder with a D50 particle size ranging from 0.5 μm to 1.0 μm;
adding the lithium powder and carbon material powder to a reactor, stirring them in a vacuum environment for carbon coating, thereby obtaining carbon-coated lithium powder; and
sintering the carbon-coated lithium powder in the vacuum environment, thereby forming the carbon-coated lithium metal particles.

11. The lithium-rich composite current collector of claim 1, wherein the polymer layer has at least one property selected from:
a puncture resistance greater than or equal to 100 gf,
a tensile strength greater than or equal to 200 MPa in the machine direction (MD),
a tensile strength greater than or equal to 200 MPa in the transverse direction (TD),
an elongation greater than or equal to 30% in the machine direction (MD), and
n elongation greater than or equal to 30% in the TD.

12. A method for preparing a lithium-rich composite current collector for use in a positive electrode, comprising:
evaporating metal to deposit a metal layer on a surface of a polymer layer; and
forming a lithium-rich layer by coating a carbon-coated lithium metal slurry on a surface of the metal layer away from the polymer layer, thereby obtaining lithium-rich composite current collector.

13. The method of claim 12, further comprising:
providing carbon-coated lithium metal particles;
dissolving PVDF in an organic solvent, and stirring them for a period of time ranging from 60 to 100 min under vacuum to obtain a mixture; and
adding the carbon-coated lithium metal particles to the mixture, and stirring them for a period of time ranging from 100 to 150 min under vacuum to obtain the carbon-coated lithium metal slurry.

14. The method of claim 13, further comprising:
jet-milling lithium metal with an inert gas to obtain lithium powder with a D50 particle size ranging from 0.5 μm to 1.0 μm;
adding the lithium powder and carbon material powder to a reactor, stirring in a vacuum environment for carbon coating, thereby obtaining carbon-coated lithium powder; and
sintering the carbon-coated lithium powder in a vacuum environment, thereby forming the carbon-coated lithium metal particles.

15. A lithium-rich composite current collector for use in a positive electrode, comprising:
a polymer layer;
two metal layers; and
two lithium-rich layers,
wherein the two metal layers are respectively disposed on the two opposite surfaces of the polymer layer, and the two lithium-rich layers are respectively disposed on the surfaces of the two metal layers away from the polymer layer.
